(19) United States
(12) Patent Application Publication
(10) Pub. No.: US 2008/0140815 A1
(43) Pub. Date: Jun. 12, 2008

(54) Network Device Location and Configuration

(75) Inventors: Dmitry Brant, Mayfield Heights, OH (US); Stephen M. Kainec, Euclid, OH (US)

Correspondence Address: CALFEE HALTER & GRISWOLD, LLP, 800 SUPERIOR AVENUE, SUITE 1400, CLEVELAND, OH, 44114, US

(73) Assignee: THE LINCOLN ELECTRIC COMPANY, Cleveland, OH (US)

(21) Appl. No.: 11/609,543

(22) Filed: Dec. 12, 2006

(51) Int. Cl. G06F 15/177

(52) U.S. Cl. 709/222

(57) ABSTRACT

A device finder locates devices connected to a network that do not have a network address assigned to them by sending a broadcast message to all connected devices independent of network address. The broadcast message requests identification information from each device. The devices on the network, including any devices that do not have a network address, send a broadcast message in response that includes device identification information. Once the identification information has been received, a network address can be assigned to the device.

### BACKGROUND

Many modern industrial plants have communication and control networks that link processing equipment throughout the facility. These networks are used to transfer information between the production environment and other functional areas such as inventory control and to allow centralized process control across multiple pieces of equipment. One common type of network used in the industrial setting is an Ethernet.

### SUMMARY

A device configuring method locates devices connected to a network that do not have a network address assigned to them. The device configuring method sends a broadcast message that is independent of network addresses to all devices connected to the network. The broadcast message requests device identification information from each device. The devices on the network, including any devices that do not have a network address, send a broadcast message in response that includes the device identification information. Once the device identification information has been received by the method, a network address can be assigned to the device.

A device finding system includes a finder message broadcast module that broadcasts a finder message that is independent of network address, a response receiver module that receives a response message from each device on the network, an address module that assigns a network address to an un-mapped device, and a configuration message broadcast module that broadcasts a configuration message that communicates the network address to the un-mapped device.

A set of welding control device finding signals configured for transmission over the Ethernet include four signals. A first signal includes a broadcast destination network address that will be received by all welding control devices in the network independent of network address and a request that each device provide a device specific identifier in response to the message. A second signal includes a broadcast destination network address that will be received by all welding control devices in the network independent of network address and a device specific identifier assigned to the responding welding control device. A third signal includes a broadcast destination network address that will be received by all welding control devices in the network independent of network address and a network address to be assigned to an un-mapped device that does not have a network address mapped to it. A fourth signal includes a broadcast destination network address that will be received by all welding control devices in the network independent of network address, an identifier that identifies the un-mapped device by device specific identifier, and the network address that is assigned to the un-mapped device.

### BRIEF DESCRIPTION OF THE DRAWINGS

FIGS. 1a-1c is a block diagram outlining a series of communication steps between devices on a network to locate and configure new devices according to an embodiment of the present invention;

FIG. 2 is a flowchart outlining a procedure for locating and configuring new devices according to an embodiment of the present invention; and

FIGS. 3 and 4 are user interface screens that allow a user to locate and configure new devices according to an embodiment of the present invention.

### DESCRIPTION

Every device that includes an Ethernet board is assigned a unique, 48 bit, MAC (Media Access Control) address. The MAC address is used to identify a particular piece of hardware. In a network setting, each device is assigned a network address, such as an IP address, which is used to identify the device's connection within the network. In order for a piece of equipment to made accessible to other devices on the Ethernet, the equipment must be assigned an IP address. Because new equipment installed in the plant may not have an IP address assigned to it yet, initialization is often performed by a method that doesn't rely on the Ethernet, such as a serial RS232 connection. During this initialization, the equipment is assigned an IP address and other configuration parameters such as a subnet mask and default gateway. Once the equipment has its IP address and is properly configured, it can function as part of the plant's Ethernet.

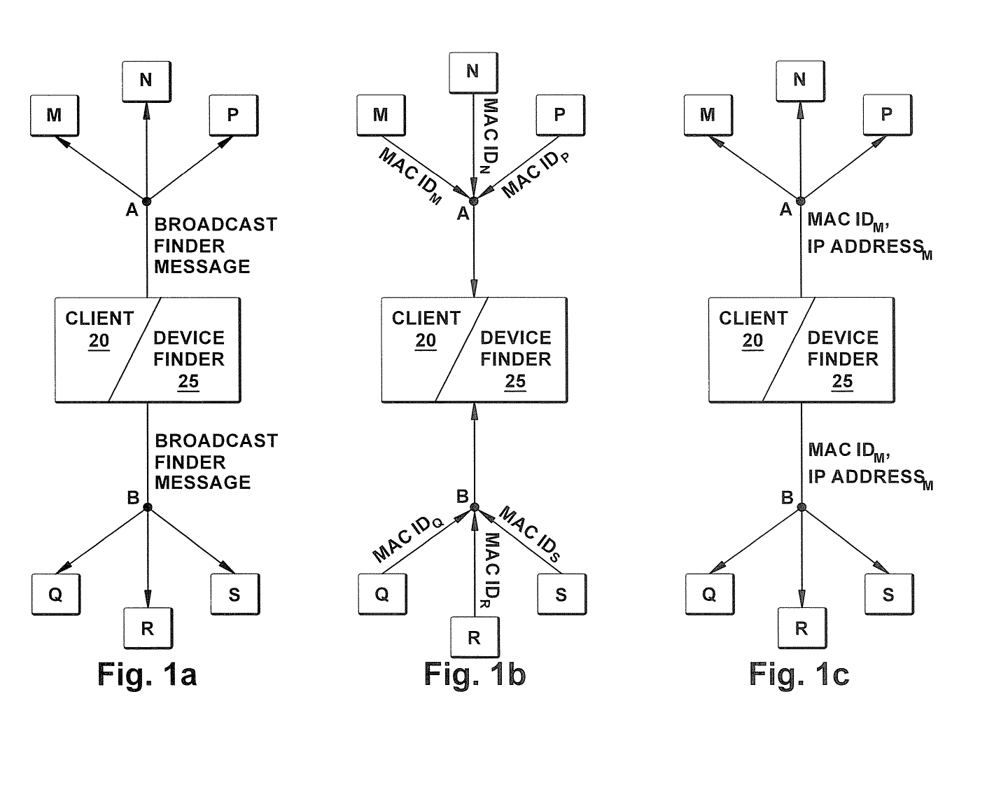

FIGS. 1a-1c illustrate schematically a network 10, such as an Ethernet, in which several host devices M-S are connected to a device finder 25 that may be part of a client computer application 20 that assigns IP addresses. In an industrial setting, the client can be a server or programmable logic controller and the host devices may be fabrication machines such as welders. The network shown in FIG. 1 includes two sub-networks, a first network including devices M-O and a second network including devices P-S. These sub-networks, often referred to as “subnets,” include gateways for each subnet, denoted A and B. A newly installed piece of equipment, for purposes of this description labeled with the “M,” is present in the network 10 and has not yet had an IP address assigned to it. Other devices on the Ethernet cannot communicate with the device M until the IP address has been assigned by the client computer application 20. As discussed in the background, device M would typically need to be configured using a method of communication outside of the Ethernet.

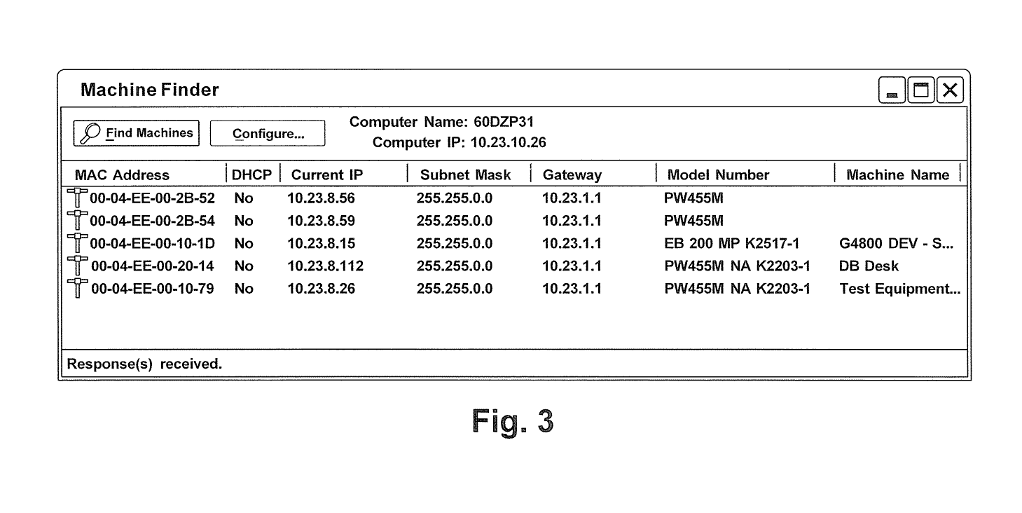

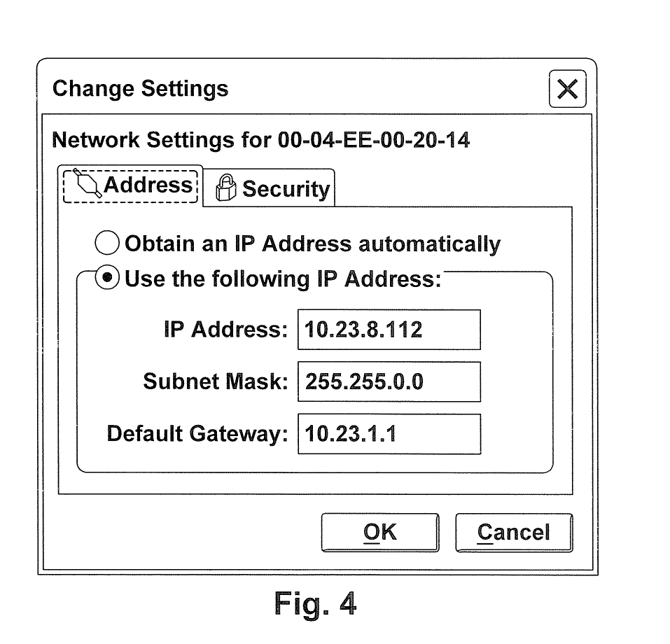

As follows, the new device can be located and assigned an IP address using the Ethernet, thereby eliminating the need for an initial device configuration that is preformed outside the Ethernet. The device finder 25 which may, for example, be included in a client application that maps devices in the network to an IP address according the MAC identifier. The device finder locates un-mapped devices on the network that do not have an IP address assigned to them. The device finder can be invoked automatically on a periodic basis or manually by a user interacting with one or more interface screens, such as, for example selecting the “Find Machines” button in the screen shown in FIGS. 3 and 4. When invoked, the device finder sends a broadcast “finder” message on the network as shown in FIG. 1a. A broadcast message is a type of message that is routed to all devices physically present in the network, and independent of IP address. For example, the finder message may have an IP address in its header portion that causes it to be received by all devices, regardless of their particular IP address. One such IP address is 255.255.255.255. The finder message prompts all of the devices on the network to respond with another broadcast message that includes in the information packet the device's MAC ID, which is the unique hardware address assigned to the device when it is manufactured. In order to assign an IP address to a device, the client needs the MAC ID of the device.

In FIG. 1b, the devices 25 are shown broadcasting a response message that includes their MAC ID. Since the response of each device is a broadcast message, the message is transmitted to all other devices, including the client. For the sake of clarity, only the response message directed to the client is shown in FIG. 1b. Once the client has received the broadcast messages, it can determine which devices do not yet have IP addresses assigned to them. A screen such that shown in FIG. 4 can then prompt a user to verify the IP address to be assigned to the un-mapped device, or the address may be assigned without user intervention.

In FIG. 1c, the client sends out another broadcast message to all devices that has the MAC ID of the new device encoded in the information packet. Any device that has a different MAC ID will ignore the message. The newly installed piece of equipment will configure itself according to the parameters included in the message. These parameters may include a subnet mask that determines which subnet the equipment will be assigned and a default gateway, A or B, through which the equipment will communicate. Once the newly installed equipment has been configured, other standard Ethernet applications (TCP, UDP, etc. . . . ) can communicate freely with the host.

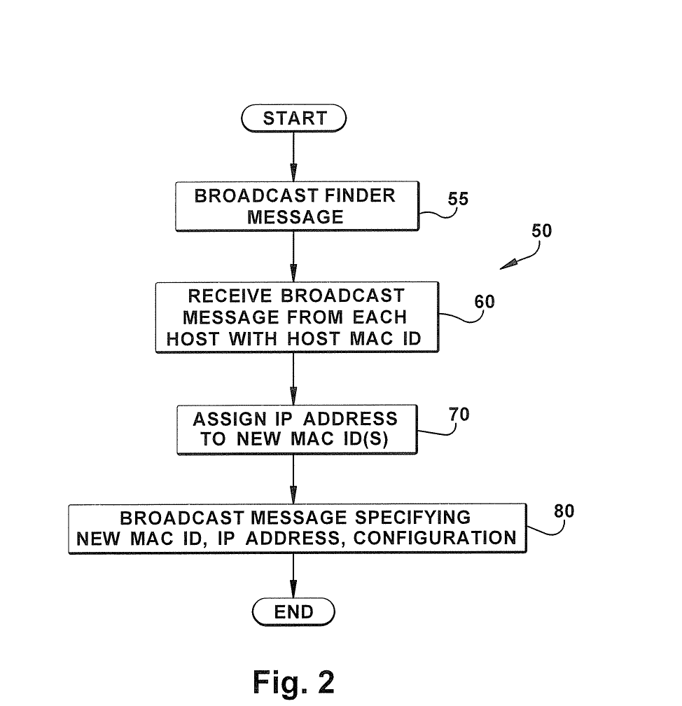

FIG. 2 is a flowchart that outlines a locating procedure 50 that can be used by a client application to locate and configure new devices. At 55 the finder message is broadcast to all hosts on the network independent of a network address. At 60, a broadcast message is received from each host on the network that provides the host's MAC ID. At 70 any host that does not have an IP address is assigned an address. At 80, a broadcast message is sent to all hosts specifying the MAC ID, IP address, and configuration information for the new host is sent by the client. At this point the new host will be configured and ready for standard communication on the network.

Having described the invention in detail, those skilled in the art will appreciate that, given the present disclosure, modifications may be made to the invention without departing from the spirit of the inventive concept herein described. Therefore, it is not intended that the scope of the invention be limited to the specific and preferred embodiments illustrations as described. Rather, it is intended that the scope of the invention be determined by the appended claims. Furthermore, the preceding description is not meant to limit the scope of the invention. Rather, the scope of the invention is to be determined only by the appended claims and their equivalents.

We claim:

1. A method that configures devices connected in a network, wherein each device has a device identifier associated with it and wherein the network includes one or more network addresses that make up the network, the method comprising:
broadcasting a finder message that is independent of network address to all devices connected to the network;
receiving, in response to the finder message, a response message from each device on the network that includes the device identifier of the responding device;
assigning a network address to an un-mapped device that does not have a network address mapped to it; and
broadcasting a configuration message to all devices connected to the network that identifies the un-mapped device by device identifier and communicates the network address that is assigned to the un-mapped device.

2. The method of claim 1 wherein the step of broadcasting a finder message is performed by addressing the message to a network address that is received by all network addresses in the network.

3. The method of claim 1 wherein the configuration message includes a subnet mask.

4. The method of claim 1 wherein the configuration message includes a default gateway address.

5. Computer readable media having computer executable instructions stored thereon for performing method steps for configuring devices connected in a network, wherein each device has a device identifier associated with it and wherein the network includes one or more network addresses that make up the network, the method steps comprising:
broadcasting a finder message that is independent of network address to all devices connected to the network;
receiving, in response to the finder message, a response message from each device on the network that includes the device identifier of the responding device;
assigning a network address to an un-mapped device that does not have a network address mapped to it; and
broadcasting a configuration message to all devices connected to the network that identifies the un-mapped device by device identifier and communicates the network address that is assigned to the un-mapped device.

6. The computer readable media of claim 5 wherein the step of broadcasting a finder message is performed by addressing the message to a network address that is received by all network addresses in the network.

7. An apparatus that configures devices connected in a network, wherein each device has a device identifier associated with it and wherein the network includes one or more network addresses that make up the network, the apparatus comprising:
means for broadcasting a finder message that is independent of network address to all devices connected to the network;
means for receiving, in response to the finder message, a response message from each device on the network that includes the device identifier of the responding device;
means for assigning a network address to an un-mapped device that does not have a network address mapped to it; and
means for broadcasting a configuration message to all devices connected to the network that identifies the un-mapped device by device identifier and communicates the network address that is assigned to the un-mapped device.

8. The apparatus of claim 7 wherein the means for broadcasting a finder message includes means for addressing the message to a network address that is received by all network addresses in the network.

9. For use with a network that includes a plurality of host devices and at least one client device that assigns network addresses to the host devices, a device finding system comprising:
a finder message broadcast module that broadcasts a finder message that is independent of network address to all devices connected to the network;
a response receiver module that receives a response message from each device on the network that includes the device identifier of the responding device;
an address assignment module that receives, from the client, a network address to an un-mapped device that does not have a network address mapped to it; and
a configuration message broadcast module that broadcasts a configuration message to all devices connected to the network that identifies the un-mapped device by device identifier and communicates the network address that is assigned to the un-mapped device.

10. The system of claim 9 wherein the modules comprise computer executable instructions stored in memory in the client device.

11. A set of signals configured for transmission over an Ethernet connecting a plurality of welding control devices comprising:
a first signal that includes: a broadcast destination network address that will be received by all welding control devices in the Ethernet independent of network address and a request that each welding control device provide a device specific identifier in response to the first signal;
a second signal that includes a broadcast destination network address that will be received by all welding control devices in the network independent of network address and a device specific identifier assigned to the responding welding control device;
a third signal that includes a broadcast destination network address that will be received by all welding control devices in the network independent of network address and a network address to be assigned to an un-mapped device that does not have a network address mapped to it; and
a fourth signal that includes a broadcast destination network address that will be received by all welding control devices in the network independent of network address, an identifier that identifies the un-mapped device by device specific identifier, and the network address that is assigned to the un-mapped device.
